(19) United States
(12) Patent Application Publication
(10) Pub. No.: US 2008/0157974 A1
(43) Pub. Date: Jul. 3, 2008

(54) METHOD OF DISABLING AND ENABLING RADIO FREQUENCY IDENTIFICATION AFTER A PREDEFINED TIME PERIOD OR EVENT

(76) Inventors: Gregory Jensen Boss, American Fork, UT (US); Peter George Finn, Brampton (CA); Rick Allen Hamilton, Charlottesville, VA (US); William Louis Moraca, McLean, VA (US)

Correspondence Address: IBM CORP (YA);C/O YEE & ASSOCIATES PC, P.O. BOX 802333, DALLAS, TX, 75380, US

(21) Appl. No.: 11/616,629

(22) Filed: Dec. 27, 2006

(51) Int. Cl. G08B 13/14

(52) U.S. Cl. 340/572.3

(57) ABSTRACT

A method and system for controlling the transmission state of a radio frequency identification transponder. A value in an event indicator is changed upon occurrence of an event. The value in the event indicator is compared to a predetermined value. Responsive to the value in the event indicator equaling the predetermined value, the transmission state of the radio frequency identification transponder is selectively changed between a first state and a second state, wherein the first state activates the radio frequency identification signal transmitted by the radio frequency identification transponder, and wherein the second state deactivates the radio frequency identification signal transmitted by the radio frequency identification transponder.

### BACKGROUND

1. Technical Field

The present invention relates generally to an improved radio frequency identification system, and in particular to a method and system for temporarily disabling and enabling radio frequency identification transponders based on a predefined time period or event.

2. Description of the Related Art

Use of Radio Frequency IDentification (RFID) technology is exploding as industry finds new ways to exploit this technology. RFID is a generic term for wireless technologies that use radio waves to automatically identify people or objects. RFID chips send a constant (unique) signal that can be read by RFID receiving equipment and then processed to enable/allow various activity. In particular, RFID employs tags, or transponders, which store information to be transmitted wirelessly in an automated fashion to specialized RFID readers, or interrogators. There are several methods of identification, but the most common is to store a “serial number” that identifies a person or object, and perhaps other information, within a tag comprising a microchip that is attached to an antenna. The “serial number” may be used to specify the unique, numerical identifier of the entity, thereby allowing a user device to distinguish one entity from another. For example, when an entity transmits a signal comprising its unique identifier and other information, an RFID-enabled mobile computing device may receive the signal and identify the entity. Applications of this technology include tracking assets, managing inventory, automatic vehicle identification, highway toll collection, and authorizing payments.

There are two kinds of RFID chips—“passive” and “active”. There are also “semi-passive” tags: http://www.morerfid.com/index.php?do=faq&topic=Introduction-8&display=RFID. Active chips have an associated power source (battery) that boosts the RFID signal so it can be recognized by receiving equipment many feet away. A familiar use of active RFID chips is the various intelligent road/bridge toll payment devices in wide use today. As a vehicle with such a device mounted on the windshield approaches the toll booth, the RFID signal is detected from the toll tag inside the vehicle and processed by the receiver proximately located at the toll booth. Upon receipt of the RFID signal, the receiver incorporates the toll fees to a customer account, which is typically charged to an associated credit card, and then provides a clearance indication (light, sound, physical barrier being removed) to the driver so that the driver may proceed, confident that the toll has been paid. Passive RFID chips send a signal with very low power so they must be very close (e.g., within inches to not greater than approximately 10 meters, depending upon design characteristics) to the receiving equipment to be read.

One familiar example of a passive RFID is the ExxonMobil® Speedpass® device that allows one to purchase gasoline (or other goods) by swiping the Speedpass device at the gas pump or point-of-sale terminal. The unique radio frequency identifies an owner with an associated credit card that is used to complete the transaction. RFID usage is increasing dramatically as organizations come up with new applications for the technology.

### BRIEF SUMMARY

The illustrative embodiments of the present invention described herein provide a method and system for controlling the transmission state of a radio frequency identification transponder. A value in an event indicator is changed upon occurrence of an event. The value in the event indicator is compared to a predetermined value. Responsive to the value in the event indicator equaling the predetermined value, the transmission state of the radio frequency identification transponder is selectively changed between a first state and a second state, wherein the first state activates the radio frequency identification signal transmitted by the radio frequency identification transponder, and wherein the second state deactivates the radio frequency identification signal transmitted by the radio frequency identification transponder.

### BRIEF DESCRIPTION OF THE DRAWINGS

The novel features believed characteristic of the illustrative embodiments are set forth in the appended claims. The illustrative embodiments, themselves, as well as a preferred mode of use and advantages thereof, will best be understood by reference to the following detailed description of an illustrative embodiment when read in conjunction with the accompanying drawings, wherein:

FIG. 1 illustrates an RFID chip according to the present invention within a conventional RFID system environment;

FIG. 2 is a block diagram of a timed expiration RFID chip in accordance with an illustrative embodiment of the present invention;

FIG. 3 is a block diagram of an event expiration RFID chip in accordance with an illustrative embodiment of the present invention;

FIG. 4 is a block diagram of a time management RFID chip in accordance with an illustrative embodiment of the present invention;

FIG. 5 is a block diagram of an RFID circuitry for enabling/disabling RFID signals in accordance with an illustrative embodiment of the present invention;

FIG. 6 is a flowchart of a process for temporarily disabling RFID signals based on expiration of a time period in accordance with an illustrative embodiment of the present invention;

FIG. 7 is a flowchart of a process for temporarily disabling RFID signals based on expiration of an event counter in accordance with an illustrative embodiment of the present invention; and

FIG. 8 is a flowchart of a process for temporarily disabling and re-enabling RFID signals based on time management in accordance with an illustrative embodiment of the present invention.

### DETAILED DESCRIPTION OF AN ILLUSTRATIVE EMBODIMENT

Illustrated embodiments of the present invention described herein provide a method and system for temporarily disabling and re-enabling RFID chips based on time and/or other events. In particular, the illustrative embodiments of the present invention provide enhanced RFID systems which combine existing RFID technology with circuitry and/or logic that allows for disabling or enabling RFID signal transmissions. The enhanced RFID chips provide a wealth of new functions which RFID technology may support and create novel possibilities for changing or creating new business models. For example, these new functions may include, among many others, self-contained product warranty management, new disposable DVD products which create an alternative business model for Blockbuster® and other video rental outlets, and self-contained cafeteria plan management for educational institutions.

In one illustrative embodiment of the present invention, signal transmissions from an RFID chip may be temporarily disabled or enabled based on expiration of a time period. In this particular embodiment, the enhanced RFID chip comprises at least a transponder and a countdown timer. The countdown timer is preset by the manufacturer to a positive value, wherein the value may represent seconds, minutes, etc. The countdown timer may be activated by an event, such as, for example, the purchase of the product onto which the RFID is attached. When the countdown timer reaches a predetermined time value (i.e., the end of the countdown time period), the enhanced RFID chip is deactivated, and thus will no longer transmit a signal.

Another illustrative embodiment of the present invention allows signal transmissions from an RFID chip to be temporarily disabled or enabled based on expiration of a defined event. In this particular embodiment, the enhanced RFID chip comprises at least a transponder, an event counter, and a timer with reset logic. At a defined time period (e.g., each day, each week, etc.) the event counter is reset to a number of allowable instances of the event. When an event occurs, a count value in the event counter is decremented by one. When the count value in the event counter reaches a predetermined value (e.g., zero), the enhanced RFID chip is deactivated, and thus will no longer transmit a signal. The enhanced RFID chip will resume transmitting a signal when the event counter is reset (e.g., the next time period).

It should be noted that the embodiments above may comprise any type of counting device. These counting devices may also count by decrementing or incrementing from the initial count value, and may decrement or increment one unit at a time or a plurality of units at a time.

Another illustrative embodiment of the present invention allows signal transmissions from an RFID chip to be temporarily disabled or enabled based on time management. In this particular embodiment, the enhanced RFID chip comprises at least a transponder, a time-of-day clock, and program logic which specifies when the RFID chip may transmit a signal (on-time) and when the RFID chip may not transmit a signal (off-time) based on defined times of the day.

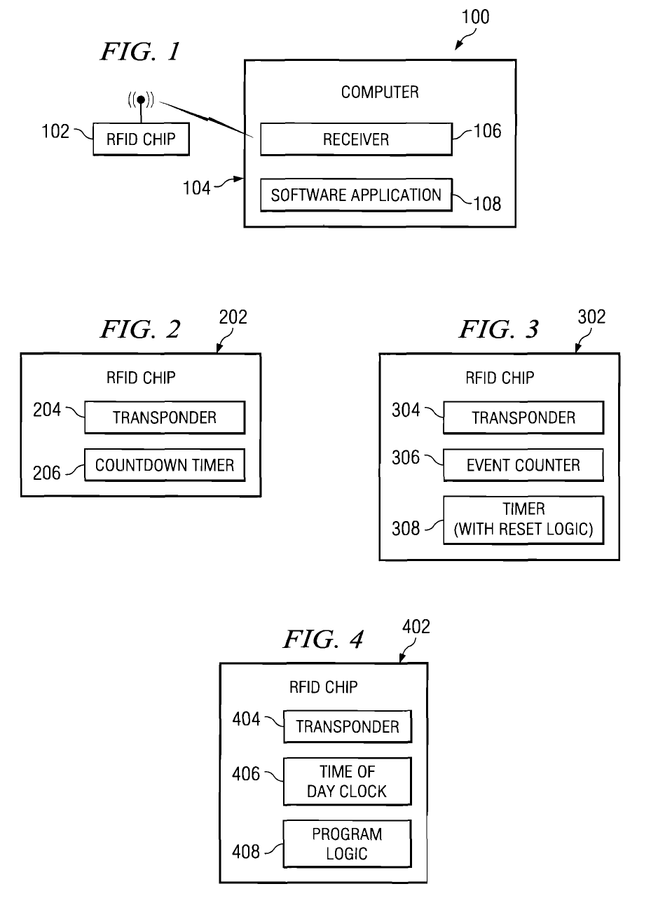

FIG. 1 illustrates an RFID chip according to the present invention within a conventional RFID system environment. In this illustrative example, distributed RFID system 100 comprises RFID chip 102 and computer 104. RFID chip 102 is a wireless communications device capable of receiving and automatically responding to incoming signals. RFID chip 102 stores information to be transmitted wirelessly in an automated fashion to specialized receivers, such as receiver 106 in computer 104. RFID chip 102 may comprise an active, passive, or semi-passive transponder, and may be affixed to a component or product. For example, a passive transponder will send no signals to a receiver until the transponder itself receives an incoming signal or it is placed within, for example, a magnetic field. If placed within a magnetic field, the magnetic field may cause a coil within the chip to produce an electric current to power the transponder and allow the transponder to transmit a signal. The signal transmitted by RFID chip 102 may then be used to identify the component to which RFID chip 102 is affixed.

RFID chip 102 transmits a signal comprising the unique identifier of the chip to computer 104. Computer 104 is an example of a data processing system. Computer 104 includes receiver 106 for receiving the signal from RFID chip 102. An example of a receiver is a radio frequency receiver, which uses an antenna to receive transmitted radio signals from another. Computer 104 also includes software application 108. Software application 108 comprises software programmed to associate RFID chip 102 with the signals the chip sends and receives. Upon receiving an incoming signal at computer 104, software application 108 is used to identify RFID chip 102 sending the signal.

FIG. 2 is a block diagram of a timed expiration RFID chip in accordance with an illustrative embodiment of the present invention. RFID chip 202 is an example transponder device, such as RFID chip 102 in FIG. 1. RFID chip 202 comprises transponder 204 and countdown timer 206. RFID chip 202 may be active, passive, or semi-passive. If RFID chip 202 is an active chip, RFID chip 202 may include a power source. Countdown timer 206 comprises a preset positive time value, such as seconds, minutes, etc. When countdown timer 206 is activated by an event, countdown timer 206 will begin counting down from the positive time value. When countdown timer 206 reaches a predetermined time value, transponder 204 is deactivated and will no longer transmit a signal.

Consider the example of a product available for purchase with a warranty. RFID chip 202 may be affixed to the product. Countdown timer 206 within RFID chip 202 is preset by the manufacturer to a positive time value (e.g., seconds, minutes, hours, etc.) which represents the product warranty period. For instance, a typical product warranty period may be valid for 90 days from the date of purchase. At the point of purchase, the retailer may swipe the product past a device which activates countdown timer 206 previously set by the manufacturer for the length of the warranty period. Countdown timer 206 will begin counting down the 90 day warranty period. If the product owner takes the product to the retailer for servicing, the retailer may swipe the product past a device which detects the signal transmitted by transponder 204. Since the retailer receives a transmission from RFID chip 202 attached to the product, the retailer is immediately notified that the product is still under warranty, and the product owner may obtain service on the product. Thus, RFID chip 202 provides self-contained warranty registration information for the product. This self-contained information may reduce the reliance on a back-end database of products, owners, and purchase dates, as well as the associated data entry, management, and expiration requirements. Such a self-contained system also allows more flexibility and less infrastructure costs. For example, the owner of a product under warranty with RFID chip 202 may obtain warranty service at more locations without the need for those locations to have an infrastructure in place to consult the back-end database. Also, convenience is provided for the consumer who no longer has to fill out and mail a warranty registration card to populate the vendor's database.

When countdown timer 206 reaches the predetermined value, transponder 204 is deactivated and will no longer transmit a signal. Thus, when the retailer swipes the product past a device and the device cannot detect a signal from RFID chip 202 on the product, the retailer is immediately informed that the warranty period for the product has expired.

Timed expiration RFID chip 202 is not only applicable to tracking product warranties, but it is applicable in any situation where a product or an attribute of the product is valid only for a period of time. For example, businesses which rent DVDs may deal with problems of managing DVD returns, collecting late fees, and keeping sufficient inventory of popular movies or games. Timed expiration RFID chip 202 embedded in “disposable” DVDs may eliminate these problems. For instance, when a customer rents a DVD, the retailer may set countdown timer 206 at a particular rental period (e.g., 24 hours, 48 hours, 168 hours, etc.). The retailer activates countdown timer 206 when the customer leaves the store. The customer may view the content of the DVD for the set time period. Once countdown timer 206 reaches the predetermined value, transponder 204 will no longer transmit a signal, and the DVD player will no longer read the DVD. It should be noted that this particular implementation would require a new DVD player which fails to play DVDs which do not transmit RFID signals.

FIG. 3 is a block diagram of an event expiration RFID chip in accordance with an illustrative embodiment of the present invention. RFID chip 302 is an example transponder device, such as RFID chip 102 in FIG. 1. RFID chip 302 may be active, passive, or semi-passive. RFID chip 302 comprises transponder 304, event counter 306, and timer 308 with reset logic. Event counter 306 is reset to a number of allowable instances of the event upon expiration of timer 308. Timer 308 may be set in any time period increment, such as seconds, minutes, hours, days, etc. After the defined time period has elapsed, the event counter is reset. When an event occurs, the count in event counter 306 may be incremented or decremented by one. When event counter 306 reaches a predetermined value (e.g., zero), transponder 304 is deactivated and will no longer transmit a signal. Transponder 304 in RFID chip 302 will only resume transmitting a signal when event counter 306 has been reset.

Event expiration RFID chip 302 may be applicable in any situation where there is a need to manage entitlement for goods or services. For example, event expiration RFID chip 302 may be embedded within meal cards to manage student meal plans at educational institutions. In this example, students on a particular meal plan are allowed to eat any two meals per day. Each day, event counter 306 is set to “2”. Event counter 306 is decremented at the point of sale when the student purchases food. After a student has made two purchases with the meal card within a given day (i.e., within the defined time period in timer 306), transponder 304 is deactivated and will no longer transmit a signal. Thus, subsequent food purchases by the student that day must be paid for by some other means. At the end of the defined time period, such as at midnight or perhaps one hour before breakfast begins, timer 308 resets event counter 306 back to “2” for that new day's meals. Once again, there is clear benefit in that the purchase authorization is self-contained, eliminating the cost of creating and managing a database of student meal plan entitlements and the communications overhead of electronic authorization. Another example of managing entitlements to goods or services includes managing access to items such as prescription methadone. Typically, patients are entitled to a certain number of doses per day, and the doses may be available at many sites in a geographic area. A patient may be given a prescription card embedded with an event expiration RFID chip 302, which the prescription provider scans when the patient makes a “purchase”. Once the event counter 306 on the entitlement card reaches the predetermined value, the patient may not obtain another dose until the next day.

FIG. 4 is a block diagram of a time management RFID chip in accordance with an illustrative embodiment of the present invention. RFID chip 402 is an example transponder device, such as RFID chip 102 in FIG. 1. RFID chip 402 may be active, passive, or semi-passive. RFID chip 402 comprises transponder 404, time-of-day clock 406, and program logic 408. Program logic 408 switches transponder 404 “on” or “off” depending upon the times of the day. In other words, program logic 408 determines when a signal may be transmitted (on-time) and when a signal may not be transmitted (off-time).

Time management RFID chip 402 may be applicable in any situation where there is a need to restrict access to specific time periods. For instance, time management RFID chip 402 may be used to enhance physical security mechanisms. In one example, access to a locked room may be available to many individuals who possess a key or passcard embedded with RFID chip 402. However, for some individuals, access to the room should be restricted to specific time periods. Thus, program logic 408 may be configured to activate transponder 404 to transmit signals during an individual's defined allowable entry hours, and to deactivate transponder 404 from transmitting signals during other defined hours. A bank safe or a research lab may benefit from this additional level of security.

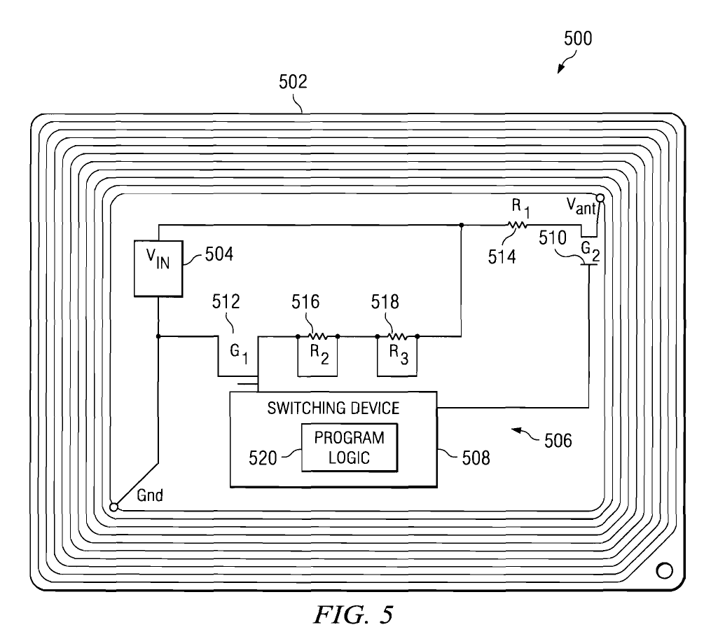

Turning now to FIG. 5, a block diagram of an RFID circuitry for enabling/disabling RFID signals is depicted in accordance with an illustrative embodiment of the present invention. RFID chip 500 is an example transponder device, such as RFID chip 102 in FIG. 1. RFID chip 500 may be active, passive, or semi-passive. RFID chip 500 comprises antenna 502 coupled to a resistive voltage network. The resistive voltage network comprises radio frequency identification chip 504, conductive path 506, switching device 508, antenna gate 510, and conductive path gate 512.

Conductive path 506 comprises resistor R1 514 and optionally, resistors R₂ 516 and R₃ 518. Conductive path 506 also comprises gate G₁ 512 coupled to switching device 508. Switching device 508 comprises program logic 520 for directing switching device 508 to open gate G₁ 512 of conductive path 506 to disable the RFID signals produced by RFID chip 500. Program logic 520 is program logic for determining whether to open or close a gate. Program logic 520 may also include logic for directing switching device 508 to close gate G₁ 512 of conductive path 506 to re-enable RFID chip 500 to generate RFID signals.

In other words, switching device 508 opens gate G₁ of conductive path 506 to disrupt or break a circuit of the resistive voltage network, thereby disabling RFID chip 500 from generating an RFID signal. Switching device 508 closes gate G₁ 512 of conductive path 506 to close or restore the circuit of resistive voltage network, and re-enables RFID chip 500 to generate RFID signals.

RFID chip 500 also includes gate G₂ 510 between antenna 502 and conductive path 506. Gate G₂ 510 is connected or coupled to switching device 508. Program logic 520 in switching device 508 controls or directs switching device 508 to open or close gate G₂ 510. If gate G₂ 510 is closed, RFID chip 500 cannot receive a transmitted signal from a RFID receiver. Thus, if both gates G₁ 512 and G₂ 510 are closed, RFID chip 500 is enabled to both send and receive signals. If gate G₂ 510 is open but gate G₁ 512 is closed, RFID chip 500 can receive a signal, but cannot transmit a signal in return. If gate G₂ 510 is closed but gate G₁ 512 is open, RFID chip 500 can receive a signal, but RFID chip 500 cannot transmit an RFID signal.

Program logic 520 is program logic for determining whether to open or close a gate. Program logic 520 may be program logic such as program logic 408 in FIG. 4.

In this example, RFID chip 500 includes both gates G₁ 512 and G₂ 510. However, in another embodiment, RFID chip 500 includes only gate G₁ 512 or gate G₂ 510. In this example, gate G₁ 512 is a single gate. However, in another embodiment, gate G₁ 512 for disrupting a conductive path, may include multiple gates for disrupting a conductive path. In such a case, each gate is coupled to switching device 508.

In another example, switching device 508 may also include a countdown timer, such as countdown timer 206 in FIG. 2. In this example, program logic 520 directs switching device 508 to close gate G₁ 512 and/or gate G₂ 510 when program logic 520 determines that the countdown timer has reached a predetermined value. In one example, the predetermined value is zero.

In another example, switching device 508 includes an event counter and/or a timer, such as event counter 306 and/or timer 308 in FIG. 3. In this example, when program logic 520 determines that the event counter has reached a predetermined value, program logic 520 directs switching device 508 to open gate G₁ 512 and/or gate G₂ 510. In this manner, switching device 508 disables RFID chip 500 from transmitting RFID signals.

In another example, switching device includes a time of day clock, such as time of day clock 406 in FIG. 4. In this example, program logic 520 controls switching device 508 to open one or more gates, such as gate G₁ 512 and/or gate G₂ 510 to disable RFID chip 500 from transmitting and/or receiving RFID signals depending on the time of day. In other words, program logic 520 determines when a signal may be transmitted and when a signal may not be transmitted by RFID chip 500. Program logic 520 may also determine when RFID signals may be received or not received by RFID chip 500.

In this embodiment, program logic 520 can control switching device 508 to re-enable RFID chip 500 to receive and/or transmit RFID signals by directing switching device 508 to open gates G₁ 512 and/or G₂ 510. Thus, in this example, RFID chip 500 may perform enabling or disabling of RFID signal transmission and reception by means of switching device 508 and program logic 520.

In this example, RFID chip 500 is enabled or disabled from sending or receiving RFID signals by opening or closing a gate. However, in accordance with the illustrative embodiments, any known or available method for enabling or disabling an RFID chip from sending and/or receiving RFID signals may be used. In other words, the illustrative embodiments are not limited to enabling or disabling RFID signal transmission by opening and/or closing gates.

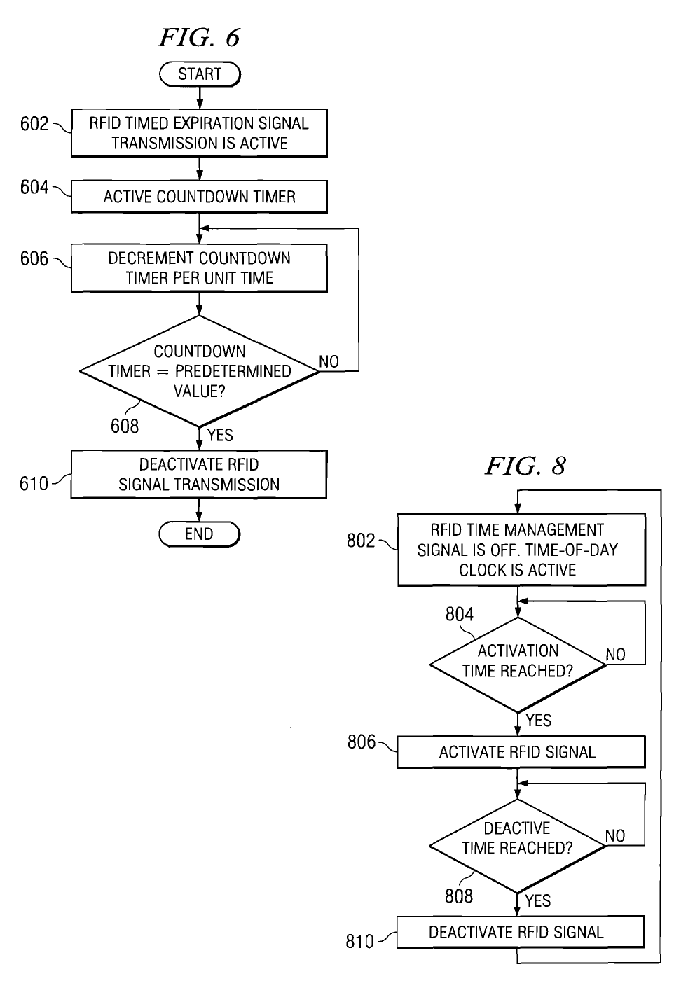

FIG. 6 is a flowchart of a process for temporarily disabling RFID signals based on expiration of a time period in accordance with an illustrative embodiment of the present invention. In this illustrative example in FIG. 6, the process may be performed by hardware and/or software for enabling/disabling transmission of RFID signals. In one example, the process may be performed by switching device 508 and/or program logic 520 in FIG. 5.

The process begins with the transmission signal of the RFID timed expiration chip being in an active state (process block 602). At a particular point in time, such as when a product to which the RFID timed expiration chip is affixed is purchased, the countdown timer in the RFID timed expiration chip is activated (process block 604). The count timer increments or decrements per unit of time (process block 606). A determination is made as to whether the time value in the count timer equals a predetermined value (process block 608). If the time value in the count timer does not equal the predetermined value (‘no’ output of process block 608), the process loops back to process block 606. If the time value equals the predetermined value (‘yes’ output of process block 608), the RFID signal is deactivated (process block 610), with the process terminating thereafter. Other functions of the product to which the RFID timed expiration chip is affixed may continue to function as usual.

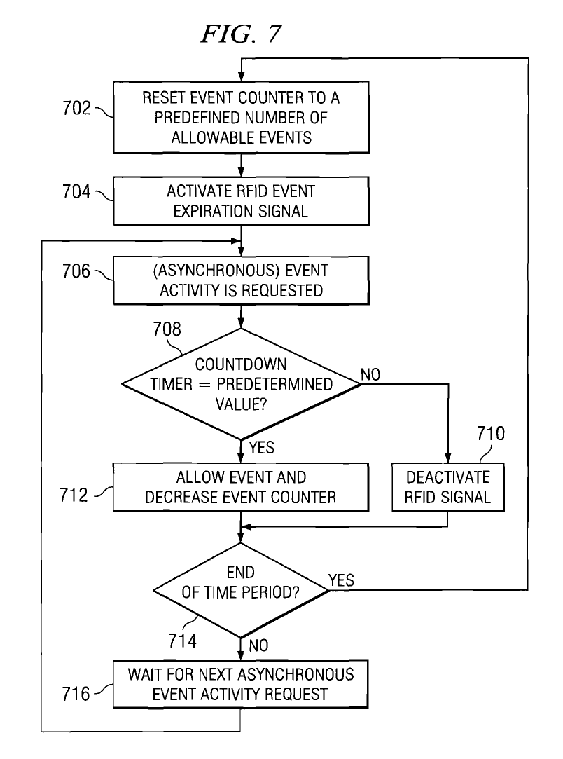

FIG. 7 is a flowchart of a process for temporarily disabling RFID signals based on expiration of an event counter in accordance with an illustrative embodiment of the present invention. In this illustrative example in FIG. 7, the process may be performed by hardware and/or software for enabling/disabling transmission of RFID signals. In one example, the process may be performed by switching device 508 in FIG. 5.

The process begins when the event counter is reset to a predefined number of allowable events (process block 702). The RFID event expiration signal is then activated (process block 704). Upon receiving an event activity request (process block 706), a determination is made as to whether the count value in the event counter in the RFID chip is equal to a predetermined value (e.g., zero) (process block 708). If the count value is equal to the predetermined value (‘yes’ output of process block 708), the RFID signal is deactivated (process block 710). If the event counter is not equal to the predetermined value (‘no’ output of process block 708), the event activity is allowed and the event counter is decremented (process block 712).

A determination is then made as to whether the time period in the timer has ended (process block 714). If the time period has ended (‘yes’ output of process block 714), the process loops back to process block 702, where the event counter is reset. If the time period has not ended (‘no’ output of process block 714), the process waits for the next asynchronous event activity request (process block 716), and loops back to process block 706 when another event activity is requested.

FIG. 8 is a flowchart of a process for temporarily disabling and re-enabling RFID signals based on time management in accordance with the illustrative embodiments of the present invention. In this illustrative example in FIG. 8, the process may be performed by hardware and/or software for enabling/disabling transmission of RFID signals. In one example, the process may be performed by switching device 508 in FIG. 5.

The process begins with the RFID time management signal disabled (i.e., set to “off”) and the time-of-day clock within the RFID time management chip active (process block 802). A determination is made as to whether the RFID signal activation time has been reached (process block 804). If the activation time has not been reached (‘no’ output of process block 804), the process loops back to process block 804. If the activation time has been reached (‘yes’ output of process block 804), the RFID signal is activated (process block 806).

A determination is then made as to whether the RFID signal deactivation time has been reached (process block 808). If the deactivation time has not been reached (‘no’ output of process block 808), the process loops back to process block 808. If the deactivation time has been reached (‘yes’ output of process block 808), the RFID signal is deactivated (process block 810). The process then loops back to process block 802.

Embodiments of the present invention may be implemented entirely in hardware, entirely in software or using a combination of both hardware and software elements. In one embodiment, the invention is implemented in software, including but not being limited to firmware, resident software, microcode, or the like.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a communication medium (e.g., a system bus). The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention embodiments in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

1. A computer implemented method for controlling a transmission state of a radio frequency identification transponder, the computer implemented method comprising:
changing a value in an event indicator upon occurrence of an event;
comparing the value in the event indicator to a predetermined value; and responsive to the value in the event indicator equaling the predetermined value, selectively changing a transmission state of the radio frequency identification transponder between a first state and a second state, wherein the first state activates a radio frequency identification signal transmitted by the radio frequency identification transponder, and wherein the second state deactivates the radio frequency identification signal transmitted by the radio frequency identification transponder.

2. The computer implemented method of claim 1, wherein the event indicator is one of a timer or an event counter.

3. The computer implemented method of claim 1, wherein the radio frequency identification transponder is affixed to a product.

4. The computer implemented method of claim 3, wherein the event is a one of a purchase of the product.

5. The computer implemented method of claim 1, wherein the event is a purchase of goods or services using a device in which the radio frequency identification transponder is embedded.

6. The computer implemented method of claim 1, wherein the event is a detection of a radio frequency identification signal.

7. The computer implemented method of claim 3, wherein the product is a disposable DVD.

8. The computer implemented method of claim 1, wherein the value in the event indicator comprises a predefined time period.

9. The computer implemented method of claim 8, wherein the pre-defined time period is one of a warranty period or a rental period.

10. The computer implemented method of claim 1, wherein the radio frequency identification transponder is one of an active, passive, or semi-passive transponder.

11. The computer implemented method of claim 2, wherein the value in the event indicator represents a number of times the event is allowed to occur within a predefined time period.

12. The computer implemented method of claim 11, further comprising:
responsive to expiration of the predefined time period, resetting the value in the event indicator to the number of times the event is allowed to occur within the predefined time period; and if the radio frequency identification signal in the radio frequency identification transponder is currently deactivated, activating the radio frequency identification signal.

13. The computer implemented method of claim 12, wherein the radio frequency identification transponder is embedded within one of a meal card or a prescription card.

14. The computer implemented method of claim 12, wherein the radio frequency identification transponder resumes transmitting the radio frequency identification signal when the value in the event indicator is reset.

15. The computer implemented method of claim 1, wherein the event indicator is a time-of-day clock located internally or externally to a radio frequency identification transponder, and wherein the event is one of an occurrence of an activation time period for the radio frequency identification signal or an occurrence of a deactivation time period for the radio frequency identification signal, and wherein the radio frequency identification signal in the radio frequency identification transponder is activated when a current time in the time-of-day clock reaches the activation time period, and wherein the radio frequency identification signal in the radio frequency identification transponder is deactivated when the current time reaches the deactivation time period.

16. The computer implemented method of claim 15, further comprising:
responsive to receiving a request for an event, identifying a state of the radio frequency identification signal as currently activated or deactivated;
if the state of the radio frequency identification signal is activated, processing the request for the event; and
if the state of the radio frequency identification signal is deactivated, denying the request for the event.

17. The computer implemented method of claim 16, wherein the request for the event is a request for access to a resource.

18. The computer implemented method of claim 15, wherein the activation time period is a time period in which access to a resource is allowed, and the deactivation time period is a time period in which access to a resource is not allowed.

19. The computer implemented method of claim 15, wherein the radio frequency identification transponder is one of an active, passive, or semi-passive transponder.

20. A system for controlling a transmission state of a radio frequency identification transponder, the system comprising:
a transponder affixed to a product for sale, wherein the transponder transmits a radio frequency identification signal, and wherein the transponder comprises:
a switching device, wherein the switching device opens a gate in a conductive path to disable the radio frequency identification signal and closes the gate to re-enable the radio frequency identification signal;
a point of sale device for receiving the radio frequency identification signal; and
a counting device comprising a count value, wherein the count value of the counting device is changed upon receipt of the radio frequency identification signal by the point of sale device;
wherein the transponder disables the radio frequency identification signal when the changed count value of the counting device equals a predetermined value.

21. A computer program product for controlling a transmission state of a radio frequency identification transponder, the computer program product comprising:
a computer usable medium having computer usable program code tangibly embodied thereon, the computer usable program code comprising:
computer usable program code for changing a value in an event indicator upon occurrence of an event;
computer usable program code for comparing the value in the event indicator to a predetermined value; and
computer usable program code for selectively changing, in response to the value in the event indicator equaling the predetermined value, a transmission state of the radio frequency identification transponder between a first state and a second state, wherein the first state activates a radio frequency identification signal transmitted by the radio frequency identification transponder, and wherein the second state deactivates the radio frequency identification signal transmitted by the radio frequency identification transponder.
